(19) United States
(12) Patent Application Publication
(10) Pub. No.: US 2014/0232876 A1
(43) Pub. Date: Aug. 21, 2014

(54) THERMAL IMAGING BEACON, SMOKE DETECTOR AND SYSTEM

(71) Applicant: Thomas P. Dougherty, Brookfield, NH (US)

(72) Inventor: Thomas P. Dougherty, Brookfield, NH (US)

(21) Appl. No.: 14/185,393

(22) Filed: Feb. 20, 2014

Related U.S. Application Data
(60) Provisional application No. 61/767,193, filed on Feb. 20, 2013.

(51) Int. Cl. G08B 17/12; H04N 5/33

(52) U.S. Cl. CPC G08B 17/125; H04N 5/33
USPC 348/165

(57) ABSTRACT

A thermal imaging beacon, a smoke detector having an integrated thermal imaging beacon, and a thermal imaging beacon system including a thermal imaging beacon and a smoke detector. The thermal imaging beacon includes a heat source, a power source, and an activation switch in communication with the heat source and power source and adapted to allow power to flow to the heat source when the switch is triggered by a fire event signal.

### CLAIM OF PRIORITY

This application claims the benefit of priority of U.S. Provisional Patent Application Ser. No. 61/767,193, filed on Feb. 20, 2013.

### FIELD OF THE INVENTION

The present invention relates to fire safety systems and, in particular, to an improved smoke detector that includes a thermal imaging beacon and to stand alone thermal imaging beacons.

### BACKGROUND OF THE INVENTION

Hundreds of children die each year as a result of residential fires and the majority of these children are those under the age of five. Such children do not have the awareness to leave a burning home and often will attempt to hide in their rooms rather than flee. Thus, firefighters are often forced to search through many rooms of a home to locate and attempt to save young children.

For many years, the “Tot Finder” fire safety program was utilized as an aid to firefighter's location of children in a burning structure. This program advocated the use of window stickers on the outside windows of children's bedrooms to alert firefighters to look specifically in those rooms for children. Unfortunately, the use of these stickers had significant drawbacks. First, firefighters typically do not enter structures through windows and the location of the sticker on the outside window often failed to assist the firefighters in finding children. Second, such stickers were not easily removed and were often left on windows after a family moved or a child was old enough to no longer be at risk, which resulted in firefighters searching for a small child who was no longer likely to be in the identified room. Finally, placing stickers in a publicly visible place served as an indicator to those who might seek to abduct children of their presence in that specific room. Accordingly, the use of these stickers is now discouraged and has been replaced with the recommendation that readily removable signs be placed on the interior doors to children's bedrooms.

The use of interior removable signs eliminated some of the problems inherent in use of window stickers. However, such signs are of little or no use in cases where, as is often the case, a house is filled with smoke and firefighters are forced to use thermal imaging cameras to navigate within the structure.

A thermal imaging camera, or “TIC”, is a device that detects differences in temperature and provides a visual image of these differences on a display. A typical TIC has five components: an optic system, a thermal detector, an amplifier, signal processing, and a display. These parts work together to render infrared radiation, such as that given off by warm objects or flames, into a visible light representation in real time. The camera display shows infrared output differentials, so two objects with the same temperature will appear to be the same “color”. Many thermal imaging cameras use grayscale to represent normal temperature objects, but highlight dangerously hot surfaces in different colors. Since thermal imaging cameras can “see” through darkness or smoke, they allow firefighters to quickly find the seat of a structure fire, or see the heat signature of visually obscured victims. Thermal imaging cameras have been credited with saving multiple lives per year through victim identification and removal from low visibility conditions. However, one significant limitation of infrared technology is that, since materials at the same temperature are shown as the same color, the display will not depict many details normally viewable in visible light. Thus, as noted above, signs placed on doors will not typically be viewable though a TIC.

Therefore, there is a need for a device that provides a visual indication of the location of a child's room to a firefighter employing a TIC.

### SUMMARY OF THE INVENTION

The present invention is a thermal imaging beacon, a smoke detector having an integrated thermal imaging beacon, and a thermal imaging beacon system including a thermal imaging beacon and a smoke detector.

In its most basic form, the thermal imaging beacon of the present invention includes an infrared source, such as a heat source or array of infrared lights, a power source, and an activation switch in communication with the infrared source and power source and adapted to allow power to flow to the infrared source when the switch is triggered.

The preferred infrared source is a heat source in the form of an electrical resistance heater that is shaped to form a desired shape that will be recognized by a firefighter employing a TIC. In some embodiments, the shape is the universal symbol for a child. In others, it is the universal symbol for a handicapped person. And still others, it is shaped to denote another identifiable symbol, such as a symbol for a bedroom, a hazardous area, such as areas where guns or ammunition are stored, an area where pets are kept, an exit, or others. In some embodiments, the heat source is a halogen light having a desired shape. And still others, the heat source is not specifically shaped but, rather, is partially covered by thermally insulating material that includes a cutout in the desired shape. In such embodiments, the thermal signature through the cutout forms the desired image on the display of the firefighters TIC.

In some embodiments, the infrared source is an array of infrared LED lights. Like the heat source, the array of infrared LED lights are preferably arranged to form a desired shape that will be recognized by a firefighter employing a TIC. In some embodiments, the shape is the universal symbol for a child. In others, it is the universal symbol for a handicapped person. And still others, it is shaped to denote another identifiable symbol, such as a symbol for a bedroom, a hazardous area, such as areas where guns or ammunition are stored, an area where pets are kept, an exit, or others. In some embodiments utilizing infrared LED lights, the array of infrared LED lights are interspersed with visible spectrum LED lights to allow firefighters to see the symbol both with and without a TIC.

The activation switch is preferably triggered by a fire detection event. In embodiments in which the thermal imaging beacon is integrated with a smoke detector, such as those described below, the activation switch is the same switch that triggers the audible alarm from the smoke detector. In embodiments in which the thermal imaging beacon is a standalone unit, the activation switch is in communication with a smoke detector system and receives a signal from the system when a fire is detected. In hardwired fire detection systems, such communication may be through the same wiring system that engages all smoke detectors in a structure. In battery-powered fire detection systems, the activation switch may be in communication with a wireless receiver that receives wireless signal from the smoke detectors, or may be a sound detector that detects the high-pitched sound of a smoke detector alarm.

The power source is preferably an alternating current source that is hardwired to the thermal imaging beacon. A hardwired system is preferred in embodiments in which the infrared source is a heat source, as the heat source will draw a significant amount of power and, therefore, may quickly drain a 9 V battery. However, in some embodiments, the thermal imaging beacon is battery-powered. In such embodiments, the battery may be a battery other than a conventional 9 V battery to allow for longer life. In other such embodiments, the thermal imaging beacon includes a delay circuit that delays the energization of the heater for a period of time after the fire has been detected in order to conserve battery power during the time that firefighters will likely be in transit to the structure.

Some embodiments of the thermal imaging beacon in which the infrared source is a heat source also include a pair of temperature sensors that sense the temperature of the air surrounding the thermal imaging beacon and the temperature of the heat source and send a signal to the activation switch that allows the flow of power to the heat source to be increased in order to ensure that there is a temperature difference between the visible surface of the heat source in the surrounding air. In such embodiments, the activation switch is part of a more comprehensive power control system that may include a processor and a power control circuit. In an alternative embodiment that includes temperature sensing, a thermoelectric cooler is placed in communication with the heater and is energized to cool the heater to a lower temperature than the surrounding air when the surrounding air reaches a temperature above safe operation temperature for the heater. The cooling of the heater renders the heater cooler than the surrounding air and this cooler area is also visible by firefighters employing a TIC.

In some embodiments of the thermal imaging beacon, a mounting bracket is provided to allow the thermal imaging beacon to be positioned such that it is easily viewed by firefighters. Some embodiments of the mounting bracket allow the beacon to be manually rotated to a more visible position. Other embodiments include an art recognized mechanism for automatically rotating the position of the thermal imaging beacon when a fire detection signal has been received.

Finally, it is preferred that the desired shape also be readily visible to firefighters who are not employing TIC's. In some such embodiments, the desired shape is of a different color than the housing of the thermal imaging beacon such that it is visible to the human eye.

The smoke detector of the present invention includes an integrated thermal imaging beacon. The preferred smoke detector is a conventional smoke detector that is either adapted to be hardwired into a system, or is battery-powered. The primary difference between the smoke detector of the present invention and conventional smoke detectors is the inclusion of the thermal imaging beacon in a location on, or proximate to, the housing of the smoke detector that will allow it to be visible to firefighters employing a TIC. In some embodiments, the housing is a conventional housing that includes an opening in the desired shape, such as those shapes described above with reference to the heater of the thermal imaging beacon. In others, the infrared source is integrated into the housing itself. In still others, the infrared source is affixed to the outside of the housing of the smoke detector.

Some embodiments of the smoke detector of the present invention are adapted to detect smoke density and to only energize the thermal imaging beacon when smoke density exceeds a predetermined level; preferably a level where firefighters will be employing a TIC.

The system of the present invention includes at least one thermal imaging beacon, at least one smoke detector, and a means for communicating a fire detection signal from the smoke detector to the thermal imaging beacon. As discussed above, this means for communicating fire detection signal may be a conventional hardwired system, a wireless communication system including a transmitter within smoke detector and a receiver within each thermal imaging beacon, or it may simply be a sound detector within the thermal imaging beacon that detects the frequency of the audible alarm of the smoke detector.

The thermal imaging beacon and smoke detector of the present invention are preferably mounted in a hallway proximate to the door of the room to which the information conveyed thereby applies. For example, a thermal imaging beacon in the shape of a child may be placed over a child's bedroom door, a thermal imaging beacon in the shape of a handicapped person may be placed over a handicapped person's bedroom door, a thermal imaging beacon in the shape of an exit sign may be placed over a exit door, etc. This placement allows firefighters employing TIC's to easily prioritize their search and/or quickly exit a structure.

Therefore, it is an aspect of the invention to provide a thermal imaging beacon that is readily viewed and understood by firefighters employing TIC's.

It is a further aspect of the invention to provide a thermal imaging beacon that may be integrated into a smoke detector.

It is a further aspect of the invention to provide a thermal imaging beacon that may be a separate unit in remote communication with a smoke detector.

It is a further aspect of the invention to provide a thermal imaging beacon that may be battery-powered.

It is a further aspect of the invention to provide a thermal imaging beacon that includes temperature sensors.

It is a further aspect of the invention to provide a system including a thermal imaging beacon and smoke detector that allows the thermal imaging beacon to be energized when the smoke detector detects a fire.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a block diagram of the basic embodiment of the thermal imaging beacon of the present invention.

FIG. 2A is a front view of a thermal imaging beacon in which the infrared source is shaped as the universal symbol for a child.

FIG. 2B is a front view of a thermal imaging beacon in which the infrared source is shaped as the universal symbol for a handicapped person.

FIG. 2C is a front view of a thermal imaging beacon in which the infrared source is shaped as a symbol for a bedroom.

FIG. 2D is a front view of a thermal imaging beacon in which the infrared source is shaped to spell the word “EXIT”.

FIG. 3A is a cut away side view of an embodiment of the thermal imaging beacon in which the infrared source is a heat source in the form of a light.

FIG. 3B is a front view of the embodiment of the thermal imaging beacon of FIG. 3A showing a cutout through the housing and insulating layer in a desired shape.

FIG. 4 is a cut away side view of an embodiment of the thermal imaging beacon that includes temperature sensing and a temperature control.

FIG. 5A is a cut away side view of an embodiment of the thermal imaging beacon in which the infrared source is an array of infrared LED lights.

FIG. 5B is a front view of the embodiment of the thermal imaging beacon of FIG. 5A showing the array of infrared LED lights arranged to spell the word “EXIT”.

FIG. 6A is a cut away side view of an embodiment of the thermal imaging beacon in which the infrared source is an array of infrared LED lights and in which visible spectrum LED lights are interspersed with the infrared LED lights.

FIG. 6B is a front view of the embodiment of the thermal imaging beacon of FIG. 5A showing the array of infrared and visible LED lights arranged to spell the word “EXIT”.

FIG. 7 is a cut away side view of an embodiment of the smoke detector of the present invention that includes a thermal imaging beacon.

FIG. 8 is a cut away side view of an embodiment of the smoke detector of the present invention that includes a thermal imaging beacon with a heat source mounted on the outside surface of the front of the housing.

FIG. 9 is a diagrammatic view of a basic embodiment of the system of the present invention.

### DETAILED DESCRIPTION OF THE INVENTION

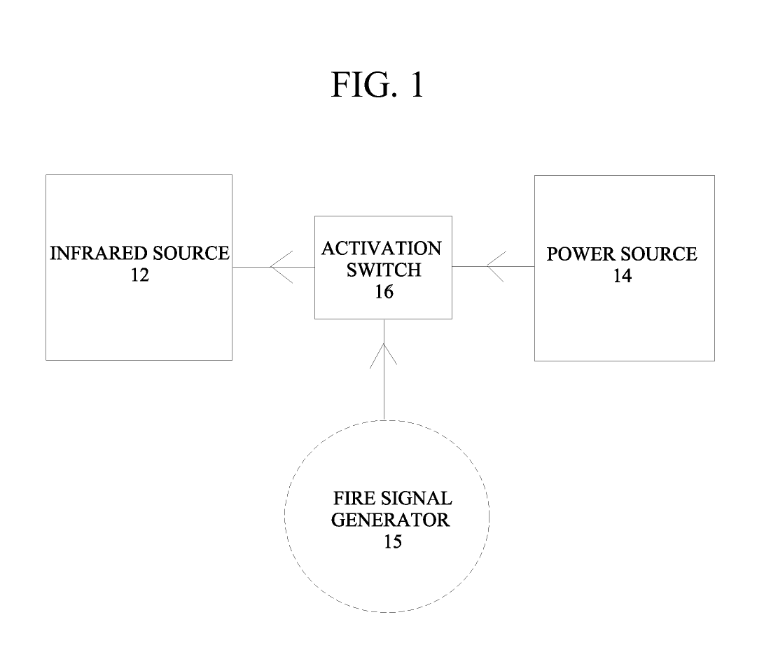

Referring first to FIG. 1, the thermal imaging beacon 10 of the present invention is shown. The thermal imaging beacon 10 includes an infrared source 12, a power source 14 and an activation switch 16 in communication with the heat source 12 and power source 14. The activation switch 16 is adapted to receive a signal from a fire signal generator 15, such as a smoke detector, or smoke detection system, and to change states to allow power to flow from the power source 14 to the infrared source 12 when a fire has been detected. It is noted that the term “smoke detector” is intended to encompass the term “smoke alarm”, which is also commonly used in the fire protection industry.

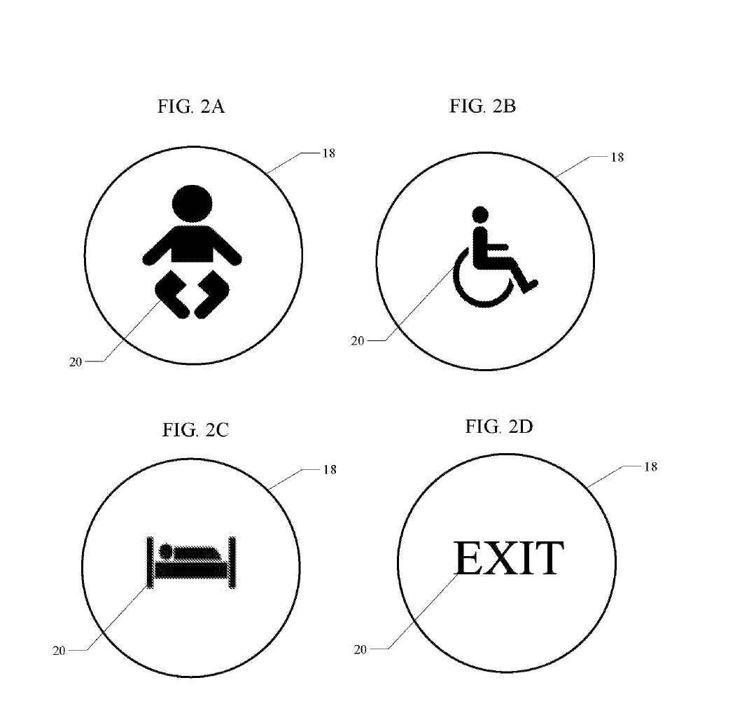

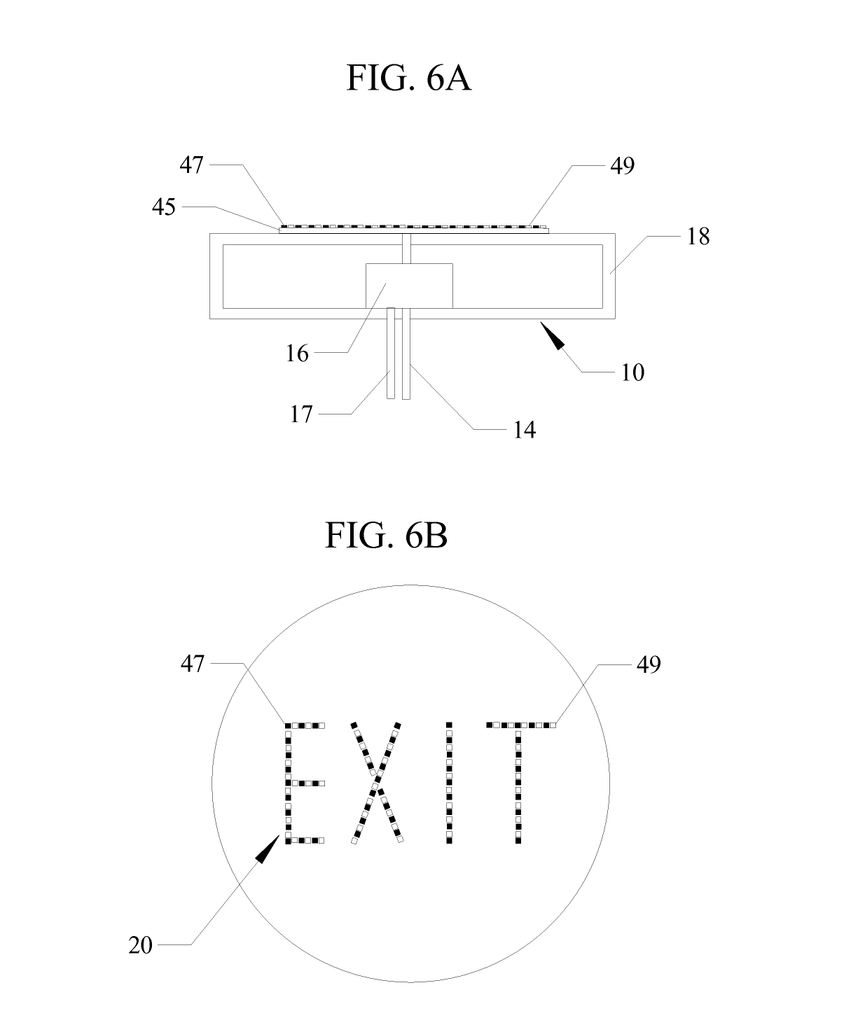

As shown in FIGS. 2A-2D, the thermal imaging beacon 10 preferably includes a housing 18 within which the in which the infrared source 12, power source 14 and activation switch 16 are disposed. This housing 18 is depicted as being similar to those commonly used in conventional smoke detectors, but it may take any form. The infrared source 12 is visible through the housing 18 and is shaped to form a desired shape 20 that will be recognized by a firefighter employing a TIC. In the embodiment of FIG. 2A, this shape 20 is the universal symbol for a child. In the embodiment of FIG. 2B, the shape 20 is the universal symbol for a handicapped person. In FIG. 2C, the shape 20 is the symbol for a bedroom. In FIG. 2D, the shape 20 is the symbol for an exit. As noted above, the shapes 20 presented in FIGS. 2A-2D are but a small sampling of the many shapes that may be readily recognized by firefighters. It is preferred that the shape 20 be readily visible to firefighters who are not employing TIC's. In FIGS. 2A-2D, the infrared source 12 is a heat source and the shape 20 is of a different color than the housing of the thermal imaging beacon such that it is visible to the human eye. However, as shown in FIGS. 6A and 6B, in embodiments in which the infrared source 12 is an array of infrared LED lights, the shape may be made visible by interspersing visible spectrum LED lights with the infrared LED lights.

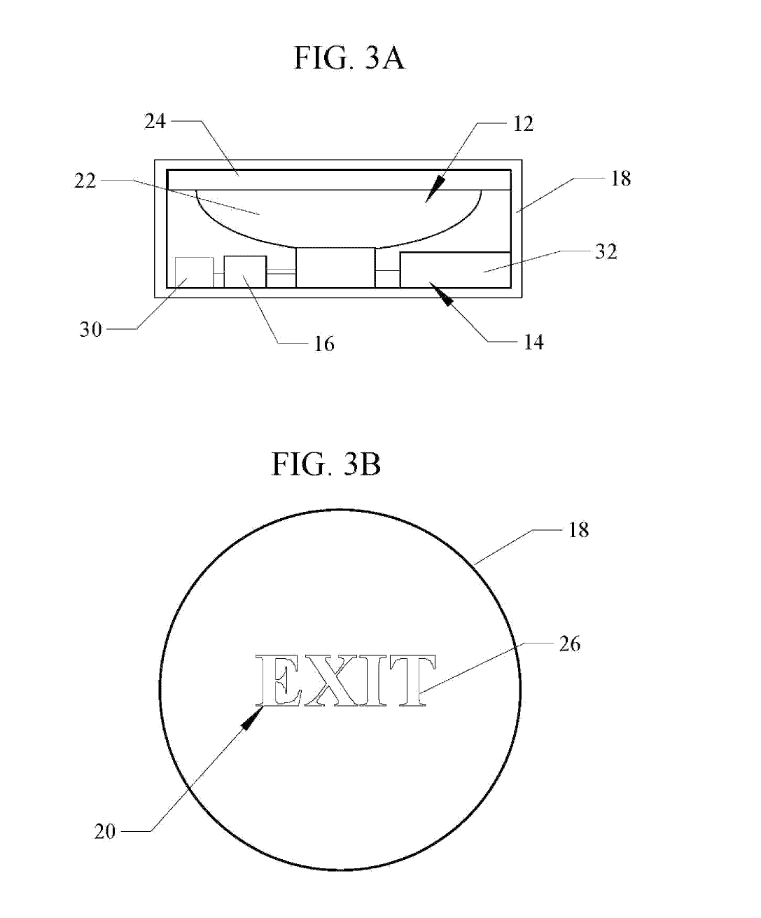

In embodiments in which the infrared source 12 is a heat source, the heat source is preferably an electrical resistance heater. However, as shown in FIGS. 3A and 3B, in some embodiments, the heat source 12 is a light 22, such as a halogen or incandescent light. This light 22 may be shaped in a desired shape. However, as shown in FIGS. 3A and 3B, it is preferred that the light 22 be a conventional light and that the light 22 is partially covered by a thermally insulating material 24 and that both the insulating material 24 and housing 18 includes a cutout 26 in the desired shape 20. In such embodiments, the thermal signature through the cutout 26 forms the desired image on the display of the firefighters TIC. The thermally insulating material 24 may take many art recognized forms, such as kapton, fiberglass, or the like and is of a thickness sufficient to partially shield the heat signature from the light 22 such that the desired shape 20 is visible through the TIC. It is noted that, in such embodiments, the use of a light also allows the desired shape 20 to be visible to firefighters who are not using a TIC.

The activation switch 16 is triggered by a fire detection event. In embodiments in which the thermal imaging beacon 10 is integrated with a smoke detector, such as those described below, the activation switch 16 is the same switch that triggers the audible alarm from the smoke detector. In embodiments in which the thermal imaging beacon 10 is a standalone unit, the activation switch 24 is in communication with a smoke detector system and receives a signal from the system when a fire is detected. In hardwired fire detection systems, such communication may be through the same wiring system that engages all smoke detectors in a structure. In the embodiment of FIGS. 3A and 3B, the power source 14 is a battery 32 and the activation switch 16 is in communication with a wireless receiver 30. This wireless receiver 30 may be adapted to receive a wireless signal from the smoke detectors, or it may take the form of a sound detector that detects the high-pitched sound of a smoke detector alarm.

In embodiments in which the infrared source 12 is a heat source, the power source 14 is preferably an alternating current source that is hardwired to the thermal imaging beacon 10. A hardwired system is preferred, as the heater will draw a significant amount of power and, therefore, may quickly drain a 9 V battery. However, as noted above, the thermal imaging beacon 10 of FIGS. 3A and 3B is battery-powered and includes a battery 32 that powers the heat source 12. In the embodiment of FIGS. 3A and 3B, the battery is a conventional 9 V battery, but it is recognized that other batteries may be utilized to allow for longer life. In the embodiment of FIGS. 3A and 3B, the activation switch 16 includes a delay circuit (not shown) that delays the energization of the heat source 12 for a period of time after the fire has been detected in order to conserve battery power during the time that firefighters will likely be in transit to the structure. It is preferred that the delay circuit be programmable to allow for different delay times to be programmed, but some embodiments may only delay energization for a set time; preferably between 5 and 10 minutes.

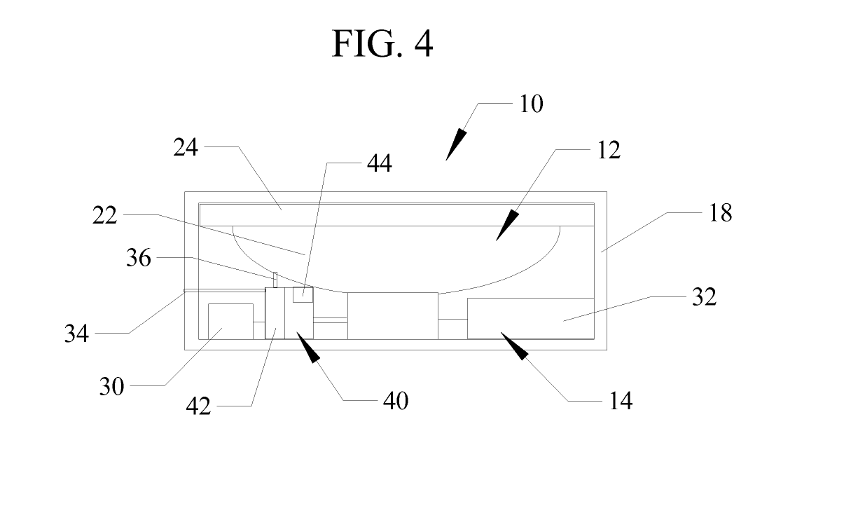

As shown in FIG. 4, some embodiments of the thermal imaging beacon 10 also include a pair of temperature sensors 34, 36. The ambient temperature sensor 34 senses the temperature of the air surrounding the thermal imaging beacon and the heat source temperature sensor 36 measures the temperature of the heat source 12. Each temperature sensor 34, 36 send a signal to the activation switch 16 that allows the flow of power to the heat source 12 to be increased in order to ensure that there is a temperature difference between the visible surface of the heat source 12 and the surrounding air. In such embodiments, the activation switch is part of a more comprehensive power control system 40 that includes a processor 42 and a power control circuit 44.

It is noted that, in an alternative embodiment that includes temperature sensing; a thermoelectric cooler (not shown) is placed in communication with the heat source 12 and is energized to cool the heat source 12 to a lower temperature than the surrounding air when the surrounding air reaches a temperature above safe operation temperature for the heat source 12. The cooling of the heat source 12 renders the heat source 12 cooler than the surrounding air and this cooler area is also visible by firefighters employing a TIC.

In some embodiments of the thermal imaging beacon 10, a mounting bracket is provided to allow the thermal imaging beacon to be positioned such that is easily viewed by firefighters. Some embodiments of the mounting bracket allow the beacon to be manually rotated to a more visible position. Other embodiments include an art recognized mechanism for automatically rotating the position of the thermal imaging beacon when a fire detection signal has been received.

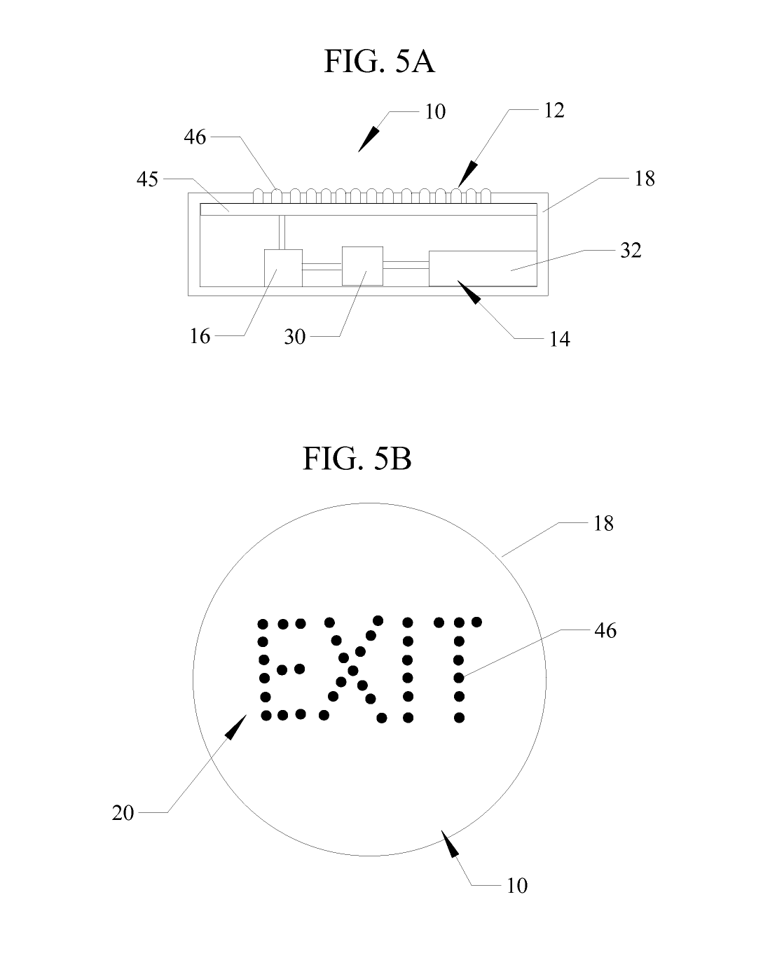

FIGS. 5A and 5B show an embodiment of the thermal beacon 10 in which the infrared source 12 is an array of infrared LED lights 46. This embodiment is a battery powered embodiment similar in all respects to the embodiment shown in FIG. 3A except for the use of an array of infrared lights 46 as the infrared source 12. In this embodiment, the infrared LED lights 46 are traditional lens style LED lights 46 that are mounted to a printed circuit board 45 disposed within the housing 18 and include lenses that protrude through openings in the top of the housing 18 and are preferably arranged to form a desired shape 20 that will be recognized by a firefighter employing a TIC. In the embodiment shown in FIG. 5B, this shape 20 is the word “EXIT”. However, the shape 20 may the universal symbol for a child, the universal symbol for a handicapped person, or another identifiable symbol, such as a symbol for a bedroom, a hazardous area, such as areas where guns or ammunition are stored, an area where pets are kept, or others.

FIGS. 6A and 6B show an embodiment of the thermal beacon 10 in which the infrared source 12 is an array of surface mounted infrared LED lights 47, denoted be a solid black color, that are mounted to a printed circuit board 45 disposed on the outside surface of the housing 18 and are arranged in a desired shape 20. However, this embodiment also includes an array of visible spectrum LED lights 49, denoted by a solid white color, that are interspersed with the infrared LED lights 47 in the same shape 20 to allow firefighters to see the symbol both with and without a TIC. The shape 20 in this embodiment is also the word “EXIT”, but may be the universal symbol for a child, the universal symbol for a handicapped person, or another identifiable symbol, such as a symbol for a bedroom, a hazardous area, such as areas where guns or ammunition are stored, an area where pets are kept, or others.

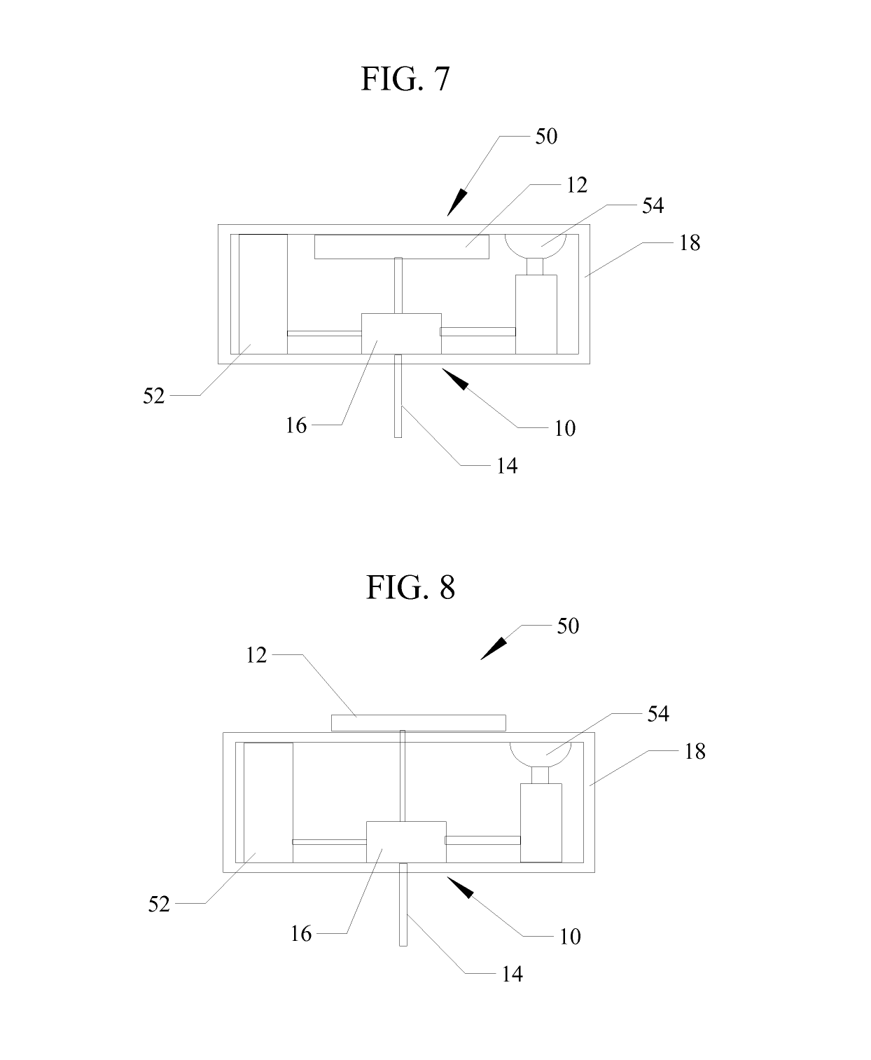

The embodiment of FIGS. 6A and 6B show a hardwired configuration in which the power source 14 and signal wire 17 each are fed in the activation switch 16 and control the energization of both the infrared LED lights 47 and visible spectrum LED lights 49. However, it is noted that the arrays of infrared LED lights 46, 47 of embodiments of FIGS. 5A and 5B and the embodiments of FIGS. 6A and 6B may replace the heat sources in any embodiment of the thermal beacon 10 or smoke detector 50 of the present invention discussed below with reference to FIGS. 7 and 8.

Referring now to FIG. 7, the smoke detector 50 of the present invention includes an integrated thermal imaging beacon 10, having at least a heat source 12, a power source 14 and an activation switch 16 in communication with the heat source 12 and power source 14. However, smoke detector 50 also includes all of the components of a conventional smoke detector, including a smoke sensor 52 and an audible alarm 54. Although the smoke detector 50 may be battery powered, the smoke detector 50 of FIG. 7 is a hardwired smoke detector 50 and the power source 14 is a power wire that enters the smoke detector 50 through the rear of the housing 18. The power source 14 terminates in the activation switch 16, which is in communication with the smoke sensor 52, the heat source 12 and audible alarm 54. When the smoke sensor 52 senses smoke around the smoke detector 50, a signal is sent to the activation switch 16, which causes power to flow to the heat source 12 and audible alarm 54.

The primary difference between the preferred smoke detector 50 of the present invention and conventional smoke detectors is the inclusion of the thermal imaging beacon 10 having a heat source 12 in a location within the housing of the smoke detector that will allow it to be visible to firefighters employing a TIC. However, as shown in FIG. 8, in some embodiments of the smoke detector 50, the heat source 12 is affixed to the outside of the housing of the smoke detector 50.

Although not described in detail, it is noted that all of the variations of the thermal imaging beacon 10 described above are readily integrated into the smoke detector 50 and the smoke detector 50 should be seen as encompassing all of these features.

Finally, it is noted that some embodiments of the smoke detector 50 of the present invention are adapted to detect smoke density and to only energize the thermal imaging beacon 10 when smoke density exceeds a predetermined level; preferably a level where firefighters will be employing a TIC.

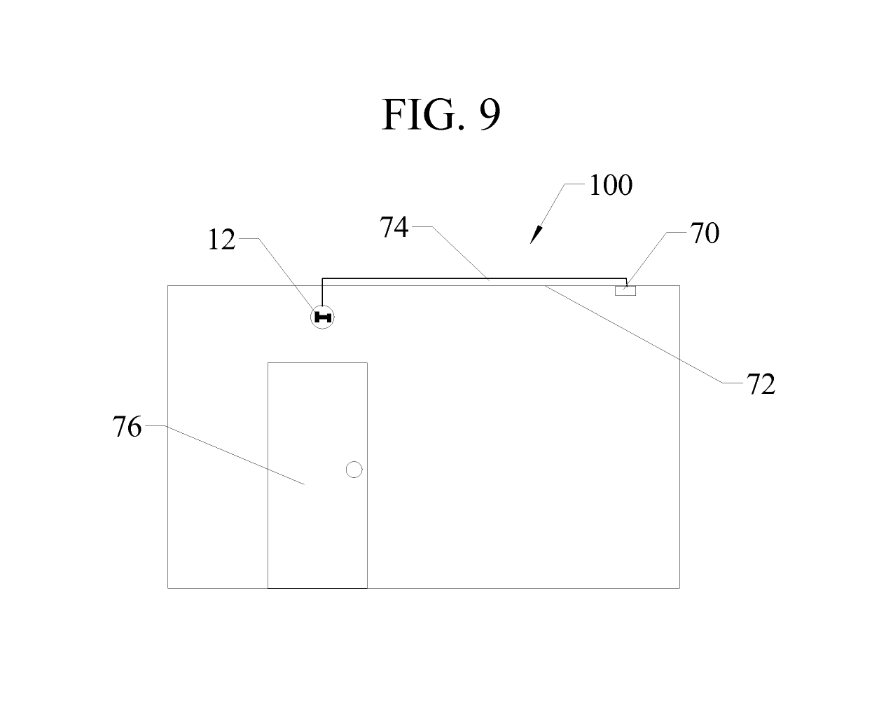

As shown in FIG. 9, the system of the present invention includes at least one thermal imaging beacon 10, and at least one conventional smoke detector 70 that is in communication with the thermal beacon 10. As shown in FIG. 9, a conventional smoke detector 70 is mounted to a ceiling 72 and the thermal imaging beacon 10 is in communication with the smoke detector 70 and is mounted directly above an exit door 76. As discussed above, although FIG. 9 shows a conventional hardwired connection 74 between the smoke detector 70 and the thermal imaging beacon 10, the means for communicating fire detection signal may also be a wireless communication system (not shown) including a transmitter within smoke detector 70 and a receiver within each thermal imaging beacon 10, or it may simply be a sound detector within the thermal imaging beacon 10 that detects the frequency of the audible alarm of the smoke detector.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A thermal imaging beacon comprising:
an infrared source capable of being viewed through a display of a thermal imaging camera;
a power source; and
an activation switch in communication with the infrared source and power source and adapted to allow power to flow to the infrared source when the switch is triggered;
wherein said infrared beacon is shaped in dimensioned such that said infrared source is viewed as a desired shape through the display of the thermal imaging camera.

2. The thermal imaging beacon as claimed in claim 1 wherein said desired shape is a shape selected from a group consisting of a symbol for a child, a symbol for a handicapped person, a symbol for a bedroom, a symbol for a hazardous area, a symbol for an area where pets are kept, and the word exit.

3. The thermal imaging beacon as claimed in claim 1 wherein said infrared source is a heat source.

4. The thermal imaging beacon as claimed in claim 3 wherein said heat source in an electrical resistance heater.

5. The thermal imaging beacon as claimed in claim 3 wherein said heat source in a halogen light.

6. The thermal imaging beacon as claimed in claim 3 further comprising a sheet of thermally insulating material having an opening therethrough;
wherein said opening is in said desired shape; and
wherein said thermally insulating material is disposed over said heat source such that a a thermal signature through said opening is viewed as said desired shape through the display of the thermal imaging camera.

7. The thermal imaging beacon as claimed in claim 1 wherein said infrared source is an array of infrared LED lights arranged to form said desired shape.

8. The thermal imaging beacon as claimed in claim 7 further comprising an array of visible spectrum LED lights interspersed with said array of infrared LED lights such that said desired shape is capable of being viewed as said desired shape through the display of the thermal imaging camera and by the human eye.

9. The thermal imaging beacon as claimed in claim 1, wherein said activation switch is in communication with a smoke detector system and receives a signal from the smoke detection system when a fire is detected.

10. The thermal imaging beacon as claimed in claim 9 further comprising a wireless receiver in communication with said activation switch, wherein said wireless receiver is capable of receiving a wireless signal from the smoke detection system when a fire is detected.

11. The thermal imaging beacon as claimed in claim 3, further comprising a delay circuit capable of delaying an energization of the heat source for a period of time after a fire has been detected.

12. The thermal imaging beacon as claimed in claim 3 further comprising a pair of temperature sensors in communication with a power control system;
wherein said power control system comprises said activation switch; and
wherein said pair of temperature sensors are capable of sensing a temperature of air surrounding said thermal imaging beacon and a temperature of said heat source and sending a signal to said power control system that allows a flow of power to the heat source to be increased such that there is a temperature difference between said heat source and the air surrounding the thermal imaging beacon.

13. The thermal imaging beacon as claimed in claim 3 further comprising a pair of temperature sensors in communication with a power control system and a thermoelectric cooler in thermal communication with said heat source;
wherein said power control system comprises said activation switch; and
wherein said pair of temperature sensors are capable of sensing a temperature of air surrounding said thermal imaging beacon and a temperature of said heat source and sending a signal to said power control system that provides a flow of power to said thermoelectric cooler such that there is a temperature difference between said heat source and the air surrounding the thermal imaging beacon.

14. A combined smoke detector and thermal imaging beacon comprising:
a housing;
a smoke sensor;
an audible alarm;
an infrared source disposed relative to said housing such that said infrared source is capable of being viewed through a display of a thermal imaging camera;
a power source; and
an activation switch in communication with said infrared source, said smoke sensor and power source and adapted to allow power to flow to the infrared source when smoke is sensed by said smoke sensor; and
wherein said infrared beacon is shaped in dimensioned such that said infrared source is viewed as a desired shape through the display of the thermal imaging camera.

15. The combined smoke detector and thermal imaging beacon as claimed in claim 14, wherein said smoke sensor is capable of detecting smoke density and wherein said activation switch is capable of only energizing said infrared source when smoke density exceeds a predetermined level.

16. The combined smoke detector and thermal imaging beacon as claimed in claim 14, wherein said desired shape is a shape selected from a group consisting of a symbol for a child, a symbol for a handicapped person, a symbol for a bedroom, a symbol for a hazardous area, a symbol for an area where pets are kept, and the word exit.

17. The combined smoke detector and thermal imaging beacon as claimed in claim 14, wherein said infrared source is a heat source.

18. The combined smoke detector and thermal imaging beacon as claimed in claim 14, wherein said infrared source is an array of infrared LED lights arranged to form said desired shape.

19. The combined smoke detector and thermal imaging beacon as claimed in claim 18, further comprising an array of visible spectrum LED lights interspersed with said array of infrared LED lights such that said desired shape is capable of being viewed as said desired shape through the display of the thermal imaging camera and by the human eye.

20. A thermal imaging beacon system comprising:
at least one smoke detector comprising:
a smoke sensor;
an audible alarm; and
means for sending a fire detection signal when said smoke sensor senses smoke; and
at least one thermal imaging beacon comprising:
an infrared source capable of being viewed through a display of a thermal imaging camera;
a power source;
means for receiving a fire detection signal from said at least one smoke detector;
an activation switch in communication with said signal input, said infrared source and power source and adapted to allow power to flow to the infrared source when a signal is received from said signal input; and
wherein said infrared beacon is shaped in dimensioned such that said infrared source is viewed as a desired shape through the display of the thermal imaging camera.
